(19) United States
(12) Patent Application Publication
(10) Pub. No.: US 2009/0007750 A1
(43) Pub. Date: Jan. 8, 2009

(54) LOW INERTIA GRAND PIANO PIANO ACTION

(76) Inventors: Bruce E. Clark, Nottingham, NH (US); Kevin Burke, Haverhill, MA (US); Kirk Burgett, Sacramento, CA (US)

Correspondence Address: CRAIG A. SIMMERMON, 251 LYMAN CIR., SACRAMENTO, CA, 95835, US

(21) Appl. No.: 11/964,148

(22) Filed: Dec. 26, 2007

Related U.S. Application Data
(63) Continuation-in-part of application No. 11/762,990, filed on Jun. 14, 2007.

(51) Int. Cl. G10C 3/16

(52) U.S. Cl. 84/239; 84/250

(57) ABSTRACT

Composite or plastic molded articles used in a grand piano piano action. The articles make up a piano action with less dynamic mass which is, thus, more responsive to the piano player. In addition, the new action provides the extremely valuable collateral benefits of increased efficiency of manufacture and maintenance.

### CROSS-REFERENCE TO RELATED APPLICATIONS

The instant application is a continuation-in-part of U.S. application Ser. No. 11/762,990 entitled “Grand Piano Composite Piano Action”, filed on Jun. 14, 2007, which is hereby incorporated by reference herein. Claims 1 and 2 of the instant application claim the benefit of U.S. application Ser. No. 11/762,990.

### BRIEF DESCRIPTION OF THE DRAWINGS

FIG. 1 is a front view of a piano action.

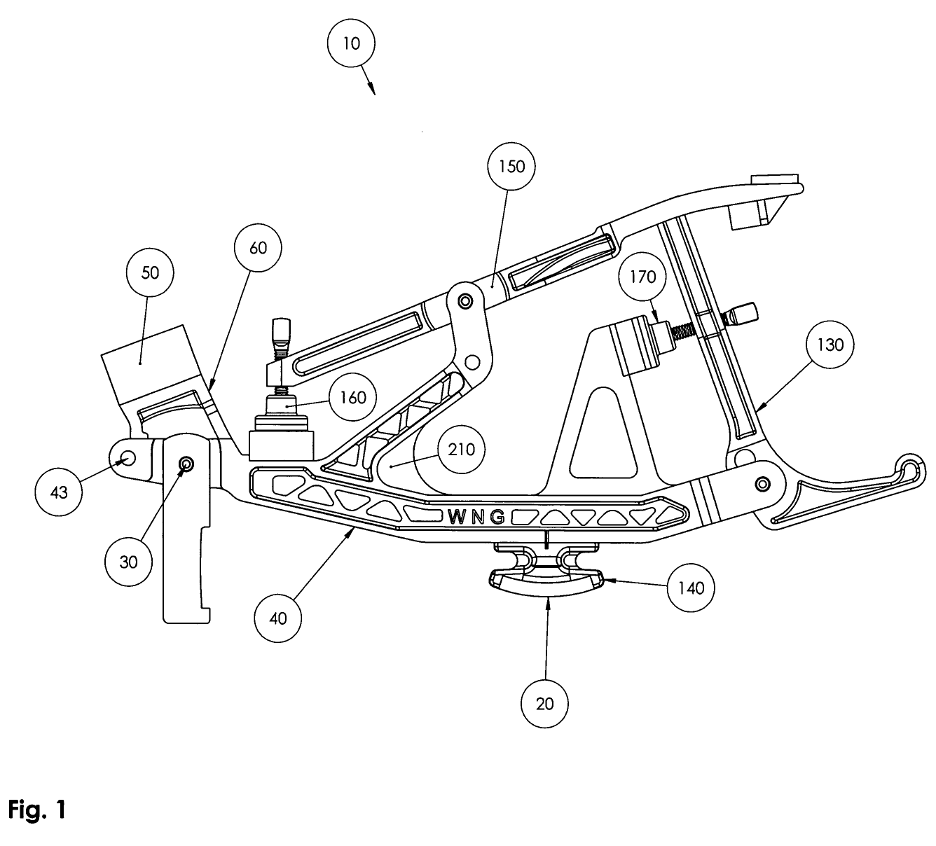

FIG. 2 is a front view of a Repetition Rest Cushion Bracket Assembly (RBA).

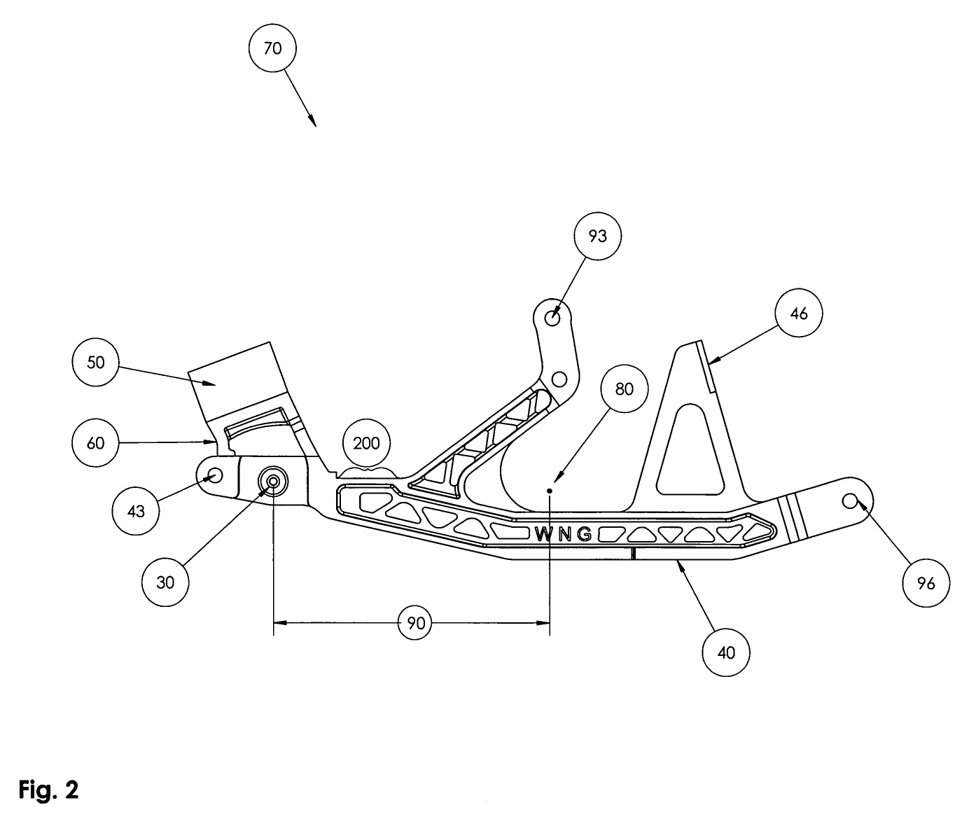

FIG. 3 is a front view of a Repetition Rest Cushion Bracket Heel Assembly (RBHA).

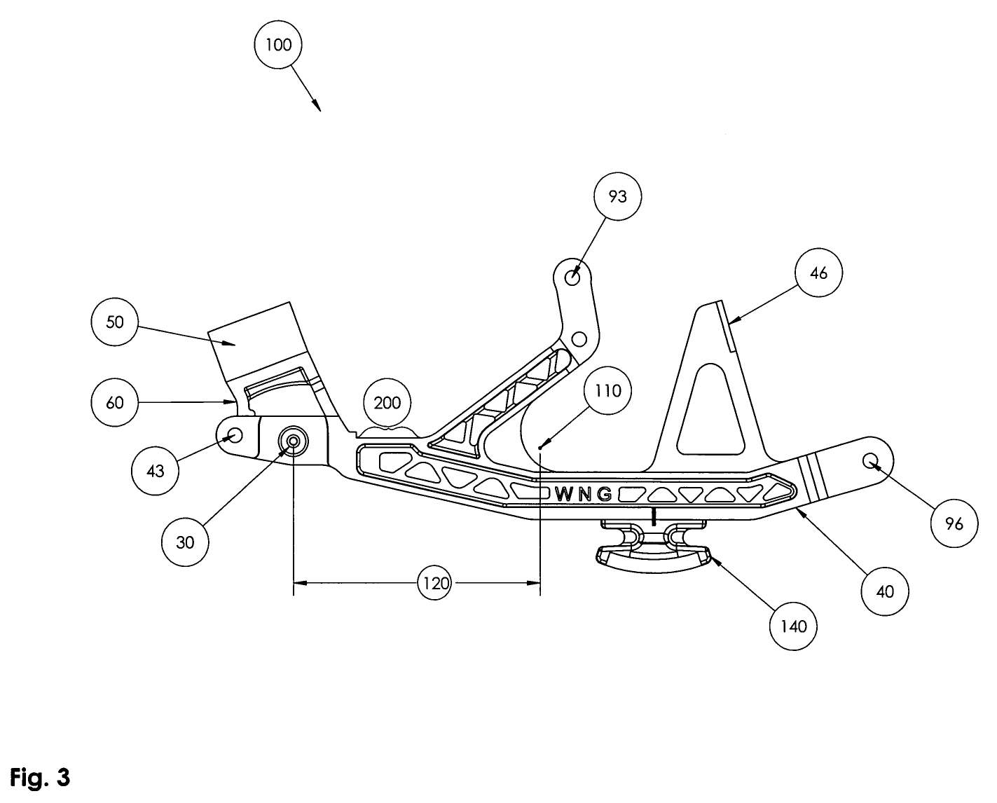

FIG. 4 is a major element break-down of a repetition base.

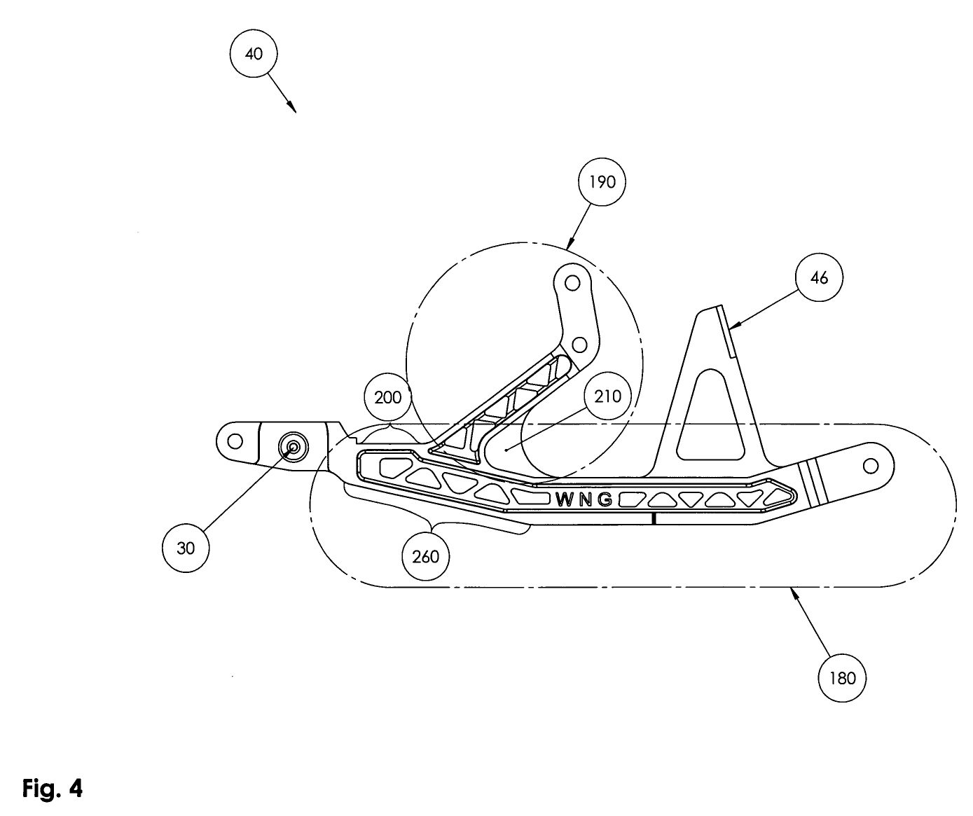

FIG. 5 describes the juxtaposition of the main beam angled section of a repetition base in relation to the whole repetition base.

FIG. 6 depicts a Prior Art Repetition Base with common points of interest called out as related to the invention.

### DEFINITION LIST

| Term | Definition |
|---|---|
| 10 | Piano Action |
| 20 | Capstan contact point |
| 30 | Repetition center of rotation |
| 40 | Repetition Base |
| 43 | Hole for “Helper Springs” |
| 46 | Stop for the Jack Regulating Button |
| 50 | Rest Cushion |
| 60 | Rest Cushion Bracket |
| 70 | Repetition Rest Cushion Bracket Assembly (RBA) |
| 80 | RBA Center of Mass |
| 90 | RBA Effective Radius |
| 93 | Balancier Attachment Hole |
| 96 | Jack Attachment Hole |
| 100 | Repetition Rest Cushion Bracket Heel Assembly (RBHA) |
| 110 | RBHA Center of Mass |
| 120 | RBHA Effective Radius |
| 130 | Jack |
| 140 | Heel |
| 150 | Balancier |
| 160 | Balancier Regulating Button |
| 170 | Jack Regulating Button |
| 180 | Repetition Main Beam |
| 190 | Balancier Support Beam |
| 200 | Balancier Regulating Button Rest Area |
| 210 | “V” Connection with Web Support |
| 220 | Main Beam/Balancier Support Beam Connection Location |
| 225 | Prior Art “T” Connection |
| 230 | Prior Art Repetition Base |
| 235 | Main Beam - Balancier Support Beam Angle |
| 240 | Effective Length of Repetition Base |
| 250 | “Main Beam/Balancier Support Beam Connection” to “Balancier |
| | Regulating Button Rest Area” Distance |
| 260 | Main Beam Angled Section |
| 270 | Line Between Repetition Base Center of Rotation and the |
| | Center of Contact Between the Heel and Repetition Base |
| 280 | Center of Contact Between the Heel and Repetition Base |

### DETAILED DESCRIPTION OF EMBODIMENT(S)

An embodiment of this invention includes a repetition base 40 with repetition main beam 180 that is not straight, as with prior art repetition bases, but rather is angled, in one section 260, toward the heel 140 of the action 10 and the capstan of the piano. A repetition base 40 with angled repetition main beam 180 results in a lower inertia piano action primarily because of two reasons.

First, an angled repetition main beam 180 that extends downward toward the heel 140 of the action allows for a much shorter heel 140. A shorter heel 140 is desirable because shorter heels weigh less than taller heels. The weights of heels 140 are very important to the moment of inertia of the piano action 10 because heels 140 are relatively heavy components of the action 10 that are located relatively far from the repetition center of rotation 30. An angled repetition main beam 180 allows for a substantial weight savings in the heel 140. For instance, a mode of heel 140, as depicted in the drawings in this application, weighs 61% less than most heels in the public domain. The main beam angled section 260 is a component of the repetition main beam 180.

Second, the “V” connection with web support 210 between the repetition main beam 180 and the balancier support beam 190 delivers much more rigidity than the prior art “T” connection 225 between analogous components of the repetition base. Thus, the increased rigidity of this design, allows for a reduction in material and mass of the article 40 in the vicinity of area 225 without compromise to the overall rigidity requirement of the piano action 10.

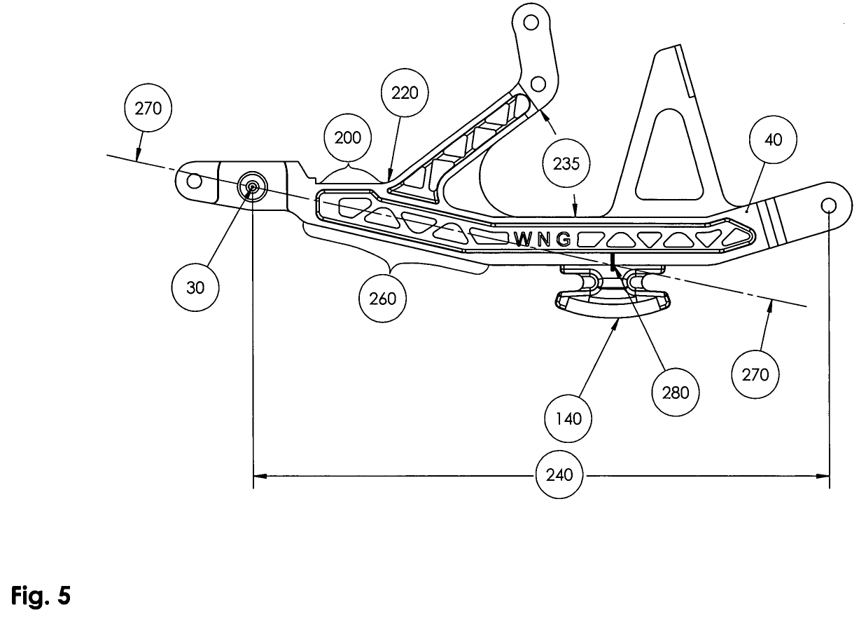

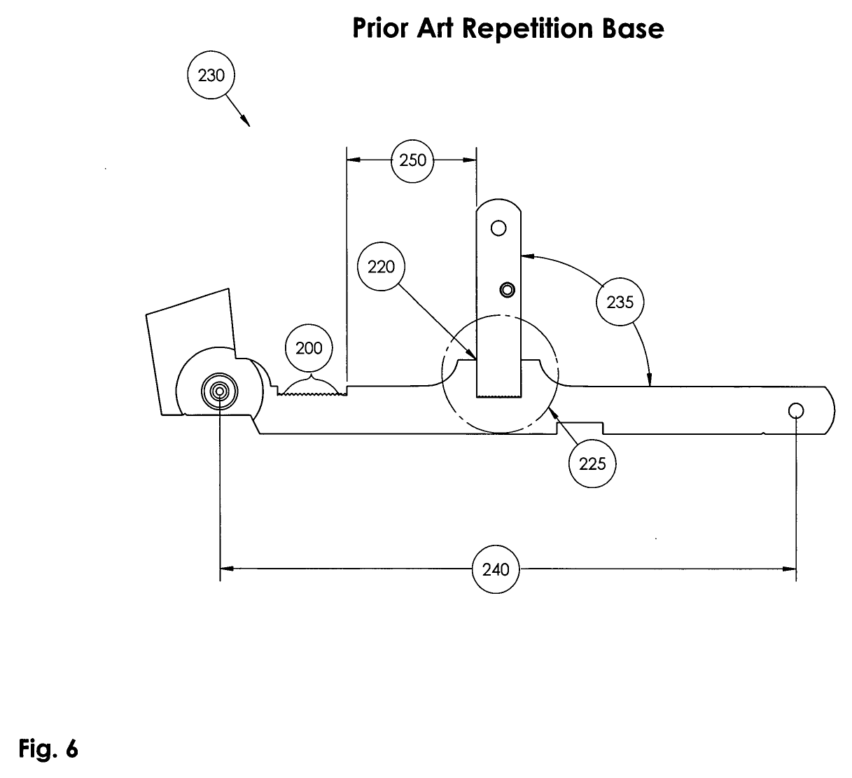

An embodiment of the repetition base 40 includes a balancier support beam 190 that connects with the repetition main beam 180 at a location 220 that is essentially immediately adjacent to the balancier regulating button rest area 200. See FIG. 5. This embodiment is within the breadth of claim 4. Prior art repetition bases have main beam/balancier support beam connection 220 that is separated from the balancier regulating button rest area 200 by a distance 250 that is typically about 25% of the effective length of the repetition base 240. See FIG. 6. The new design moves mass of the repetition base 40 towards the repetition center of rotation 30, thus reducing the moment of inertia of the piano action 10, without sacrificing rigidity.

The repetition base 40 also includes a novel connection angle 235 between the repetition main beam 180 and balancier support beam 190. This angle 235 has always been essentially 90 degrees. See FIG. 6 for a depiction of prior art. As a result of the scientific method described above to move mass, reduce mass, and improving rigidity of the repetition base 40, we now have an acute angle 235 as seen on FIG. 5. The mode of the repetition base 40 depicted here is within the breadth of claim 3.

The moment of inertia of a rigid body rotating about a fixed axis is ∫r² dm, where r is the distance from center of rotation to the differential mass point of the body dm. The moment of inertia of a piano action component can be approximated by: (the distance from center of rotation to the center of mass)²×(mass).

The moment of inertia of a repetition base 40 with rest cushion bracket 60 and rest cushion 50 attached, hereby known as a repetition rest cushion bracket assembly (RBA) 70, can be accurately approximated using the distance from repetition center of rotation 30 to the RBA center of mass center of mass 80—hereafter know as the RBA effective radius 90—and the mass of the RBA. A mode of this invention has a moment of inertia equal to 17,456 gmm² from a RBA weight of 9.35 grams and RBA effective radius of 43.19 mm.

The moment of inertia of repetition base 40 with rest cushion bracket 60, rest cushion 50, and heel 140 attached, hereby known as a rest cushion bracket heel assembly (RBHA) 100, can be accurately approximated using the distance from repetition center of rotation 30 to the RBHA center of mass center of mass 110—hereafter know as the RBHA effective radius 120—and the mass of the RBHA. A mode of this invention has a moment of inertia equal to 20,861 gmm² from a RBHA weight of 10.31 grams and RBHA effective radius of 44.97 mm.

What is claimed is:

1. A repetition rest cushion bracket assembly for a grand piano piano action with moment of inertia between 14,500-18,500 gram mm².

2. A repetition rest cushion bracket heel assembly for a grand piano piano action that has moment of inertia between 17,500-22,000 gram mm².

3. A repetition base for a grand piano piano comprising: a main beam and a balancier support beam, wherein said balancier support beam is connected to said main beam at an angle (225) measuring 5-45 degrees.

4. A repetition base for a grand piano piano action as in claim 3, further comprising: a balancier regulating button rest area, wherein the attachment point (220) between said balancier support beam and said main beam is separated from said balancier regulating button rest area (200) by a distance (250) that is less than 15% of the effective length (240) of said repetition base for a grand piano piano action.

5. A repetition base for a grand piano piano action comprising: a main beam, wherein said main beam is not straight, but further comprises one or more main beam angled sections.

6. A repetition base for a grand piano piano action as in claim 5, wherein one of said one or more main beam angled sections (260) has orientation that essentially coincides with a hypothetical line (270) between the repetition base center of rotation (30) and the center of contact (280) between the heel and said repetition base for a grand piano piano action.

7. A heel for a grand piano piano action that weighs 0.75-1.75 grams.
